(19) United States
(12) Patent Application Publication
(10) Pub. No.: US 2018/0019454 A1
(43) Pub. Date: Jan. 18, 2018

(54) POWER SUPPLY DEVICE AND VEHICLE PROVIDED WITH POWER SUPPLY DEVICE

(71) Applicant: SANYO Electric Co., Ltd., Osaka (JP)

(72) Inventors: WATARU OKADA, Hyogo (JP); YOSHIAKI UETA, Shizuoka (JP); SHUICHI SUGAWARA, Miyagi (JP); YOSHIHIRO SHIOTSU, Osaka (JP)

(21) Appl. No.: 15/545,719

(22) PCT Filed: Dec. 9, 2015
(86) PCT No.: PCT/JP2015/006129

§ 371 Date: Jul. 23, 2017

(30) Foreign Application Priority Data
Mar. 31, 2015 (JP) 2015-073507

(51) Int. Cl. H01M 2/10; B60L 11/18; H01M 10/04

(52) U.S. Cl. CPC H01M 2/1077; H01M 2/1094; H01M 10/0481; B60L 11/1877; B60L 11/1879; H01M 2220/20

(57) ABSTRACT

The power supply device includes a plurality of battery cells each having a rectangular outer shape; separators each interposed between the battery cells and insulating mutually adjacent battery cells; and fastening members for fastening a battery cell stack including the alternately stacked battery cells and the separators. The separator includes a sandwiching plate portion disposed between the facing principal surfaces of the mutually adjacent battery cells, and a plate-like bottom-surface cover portion provided to both surfaces of the sandwiching plate portion, at a lower end of the sandwiching plate portion, and protruding in a stacked direction of the battery cells to cover bottom surfaces of the battery cells. The bottom-surface cover portions of the separators stacked on both surfaces of the battery cells are stacked on each other at the bottom surfaces of the battery cells.

### TECHNICAL FIELD

The present invention relates to a power supply device for a large electric current used for a power supply of a motor for driving a vehicle such as a hybrid car and an electric automobile, and a vehicle provided with the power supply device.

### BACKGROUND ART

A power supply device in which a plurality of battery cells each including a rectangular-shaped outer is stacked is used in on-vehicle applications. In such battery cells, in a conductive outer can, positive and negative electrode plates are housed and an electrolytic solution filled. Consequently, the outer can has an electric potential. Therefore, adjacent outer cans of stacked battery cells need to be insulated from each other. As such an insulating structure, for example, some configurations have been proposed in which a surface of a battery cell is covered with a shrink tube (see, for example, Patent Literature 1), a case made of resin is used, or the inside of an outer can is insulated so that the outer can does not have an electric potential.

However, since any methods require corresponding cost and labor, a more simple and inexpensive insulating structure for battery cells has been demanded. For example, since condensed water droplets enter a bottom surface side of battery cells, it is necessary to insulate bottom surfaces of the outer cans from each other. Furthermore, in order to maintain a battery cell stack in which battery cells are stacked in a fastened state, a fastening member such as a bind bar may be used, and the fastening member may be made by bending a metal plate. When the fastening member is made of metal, a structure for preventing outer cans from being conductive to each other through the fastening member has been required.

### CITATION LIST

### Patent Literature

PTL 1: Japanese Patent Application Unexamined Publication No. 2012-190674

### SUMMARY OF THE INVENTION

### Technical Problem

The present invention has been made in order to solve these conventional problems. An object of the present invention is to provide a power supply device capable of effectively preventing short-circuit due to condensed water and the like by securing a creepage distance between a battery cell and a fastening member while a structure for insulating battery cells from each other is simplified, and to provide a vehicle including the power supply device.

### Solution to Problem

The power supply device of the present invention includes a plurality of battery cells 1 each having a thickness thinner than a width of principal surface 1X and having a rectangular outer shape; separators 2 each interposed between battery cells 1 and insulating mutually adjacent ones of battery cells 1 from each other, in a state that the plurality of battery cells 1 are stacked with principal surfaces 1X facing each other; and fastening members 3 for fastening battery cell stacks 9 in which battery cells 1 and separators 2 are alternately stacked on each other. Separator 2 includes sandwiching plate portion 20 disposed between facing principal surfaces 1X of mutually adjacent battery cells 1, and plate-like bottom-surface cover portion 23 provided to both surfaces of sandwiching plate portion 20, at a lower end of sandwiching plate portion 20, and protruding in a stacked direction of battery cells 1 to cover bottom surfaces of battery cells 1. In the power supply device, bottom-surface cover portions 23 of separators 2 stacked on both surfaces of battery cell 1 are stacked on each other at the bottom surfaces of battery cells 1.

With the above-mentioned configurations, the bottom surfaces of the battery cells are not exposed, and furthermore, the bottom-surface cover portions of the separators stacked on both surfaces of the battery cells are stacked to each other at the bottom surfaces of adjacent battery cells to cover the bottom surfaces. Thereby, a creepage distance can be increased and insulating property can be enhanced.

In the power supply device of the present invention, bottom-surface cover portion 23 includes middle cover portion 23X that covers a middle part in the width direction of bottom surfaces of battery cells 1; and end cover portion 23Y that covers both ends in the width direction of bottom surfaces of battery cells 1. A stacked width (H1) in end cover portion 23Y can be made larger than a stacked width (H2) in middle cover portion 23X.

The above-mentioned configuration permits reliably insulation by increasing the creepage distance by increasing a stacked width in the both ends of the bottom surface of the battery cell, while a stacked width in the middle part of the bottom surface of the battery cell can be reduced and a separator can be simplified.

In the power supply device of the present invention, fastening member 3 includes a pair of end plates 4 disposed to both end surfaces of battery cell stack 9, and bind bar 5 having both ends connected to the pair of end plates 4; bind bar 5 includes side plate portion 5X for covering at least a part of the side surface of battery cell stack 9, and lower-end bending portion 5B extending from the lower end of side plate portion 5X, and covering a part of the bottom surface of battery cell stack 9. Separator 2 includes end cover portion 23Y at a site corresponding to lower-end bending portion 5B.

With the above-mentioned configuration, the battery cell stack is fastened by the fastening member. Meanwhile, bottom surface cover pieces that are stacked on each other make it possible to prevent the lower-end bending portion from short-circuiting the bottom surfaces of the adjacent battery cells. In particular, insulation can be reliably achieved by the end cover portion in which the stacked width of the battery cells at the both ends of the bottom surface is increased and a creepage distance can be increased.

In the power supply device of the present invention, the bottom-surface cover portion 23 includes first bottom-surface cover portion 23A protruding to a first surface side of sandwiching plate 20, and second bottom-surface cover portion 23B protruding to a second surface side of sandwiching plate 20. First bottom-surface cover portion 23A of separator 2 stacked on first principal surface 1Xa of battery cell 1, and second bottom-surface cover portion 23B of separator 2 stacked on second principal surface 1Xb of battery cell 1 can be stacked on each other on the bottom surfaces of battery cells 1.

In the power supply device of the present invention, first bottom-surface cover portion 23A and second bottom-surface cover portion 23B are formed to be gradually thinner from sandwiching plate 20 to a tip end, and facing surfaces that are stacked on each other are formed as tapered surfaces 26. The facing surfaces of first bottom-surface cover portion 23A and second bottom-surface cover portion 23B can be closely attached to each other in such a state that battery cell stack 9 is fastened by fastening members 3.

The above-mentioned configuration can achieve reliable insulation by closely attaching the tapered surfaces provided to the facing surfaces of the first bottom-surface cover portion and the second bottom-surface cover portion in a state in which the separators disposed to the both surfaces of the battery cell are pressed in an approaching direction. In particular, they can be closely attached while clearance can be absorbed when the facing surfaces are made to be tapered surfaces.

In the power supply device of the present invention, separator 2 includes upper-end cover portion 24 provided to both surface sides of sandwiching plate portion 20, at an upper end of sandwiching plate portion 20, and protruding in a stacked direction of battery cells 1 to cover an upper surface side of battery cells 1. Upper-end cover portion 24 of separators 2 stacked on both surfaces of battery cells 1 are stacked on each other at the upper surface side of battery cells 1.

With the above-mentioned configuration, in the upper surface side of the adjacent battery cells, by stacking and covering the upper-end cover portions of the separators, the creepage distance of this portion is increased and the insulating property can be enhanced.

In the power supply device of the present invention, fastening member 3 includes a pair of end plates 4 disposed on both end surfaces of battery cell stack 9, and bind bar 5 having both ends coupled to the pair of end plates 4. Bind bar 5 includes side plate portion 5X for covering at least a part of a side surface of battery cell stack 9, and upper-end bending portion 5A that extends from the upper end of side plate portion 5X and covers a part of an upper surface of battery cell stack 9. Separator 2 includes upper-end cover portion 24 at a site facing upper-end bending portion 5A.

With the above-mentioned configuration, the battery cell stack is fastened by the fastening member. Meanwhile, upper surface cover pieces that are stacked on each other make it possible to prevent the upper-end bending portion from short-circuiting the upper surfaces of the adjacent battery cells.

In the power supply device of the present invention, in separator 2, a width (W) of sandwiching plate portion 20 can be made larger than a width (D) of battery cell 1.

With the above-mentioned configuration, both side portions of the sandwiching plate portion can be allowed to protrude from the side surface of the battery cell, and thus, a creepage distance between the adjacent battery cells can be secured to achieve reliable insulation.

In the power supply device of the present invention, separator 2 has recesses and projections seen in a cross-sectional view of sandwiching plate portion 20, thereby forming a plurality of lines of air passages 6 between sandwiching plate portion 20 and principal surfaces 1X of the facing stacked battery cells.

The above-mentioned configuration makes it possible to ideally form a plurality of lines of air passages between the sandwiching plate portion and the battery cells.

A vehicle of the present invention can include any one of the above-mentioned power supply devices.

### BRIEF DESCRIPTION OF THE DRAWINGS

FIG. 1 is a perspective view of a power supply device in accordance with one exemplary embodiment of the present invention.

FIG. 2 is an exploded perspective view of the power supply device shown in FIG. 1.

FIG. 3 is a partially enlarged sectional view taken on line of the power supply device shown in FIG. 1.

FIG. 4 is an exploded perspective view showing a stacked structure of battery cells and separators.

FIG. 5 is an exploded perspective view showing a stacked structure of end plates, battery cells, and separators.

FIG. 6 is a sectional view taken on line VI-VI of the power supply device shown in FIG. 1.

FIG. 7 is an enlarged sectional view showing a principal part of a battery system shown in FIG. 1, corresponding to a cross-section taken on line VII-VII of FIG. 6.

FIG. 8 is an enlarged sectional view showing a principal part of the battery system shown in FIG. 1, corresponding to a cross-section taken on line VIII-VIII of FIG. 6.

FIG. 9 is an enlarged sectional view showing a state in which separators are stacked on both surfaces of a battery cell.

FIG. 10 is a block diagram showing an example in which a power supply device is mounted on a hybrid vehicle driven by an engine and a motor.

FIG. 11 is a block diagram showing an example in which a power supply device is mounted on an electric automobile only driven by a motor.

### DESCRIPTION OF EMBODIMENTS

A power supply device of the present invention is used for various applications, for example, a power supply installed in an electric-powered vehicle such as a hybrid car or an electric automobile to supply electric power to a driving motor, a power supply for storing natural energy power generated, by, for example, solar power and wind power, a power supply for storing late-night electric power, or the like, and particularly is used as a power supply suitable for applications for large electric power and a large electric current.

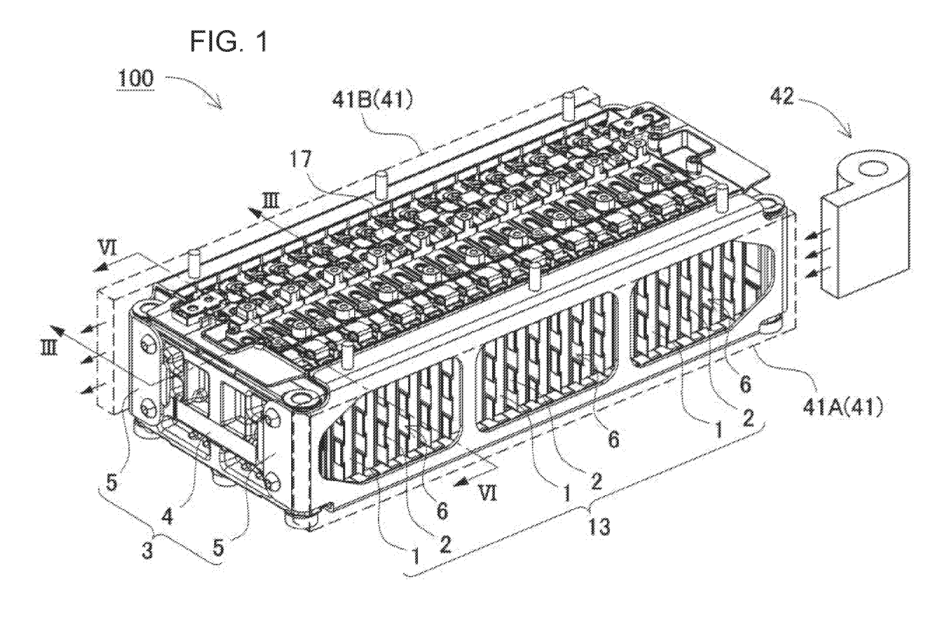

Power supply device 100 in accordance with one exemplary embodiment of the present invention is shown in FIG. 1. Power supply device 100 shown in FIGS. 1 to 8 includes a plurality of battery cells 1 each having a rectangular outer shape; separators 2 interposed between battery cells 1 in a state in which the plurality of battery cells 1 are stacked; and fastening members 3 for fastening battery cell stack 9 in which the plurality of battery cells 1 and separators 2 are alternately stacked on each other. In power supply device 100 shown in the drawings, the plurality of battery cells 1 of rectangular cells are stacked with air passage 6 provided therebetween. In power supply device 100, cooling air is supplied to air passage 6 for cooling each battery cell 1.

### (Battery Cell 1)

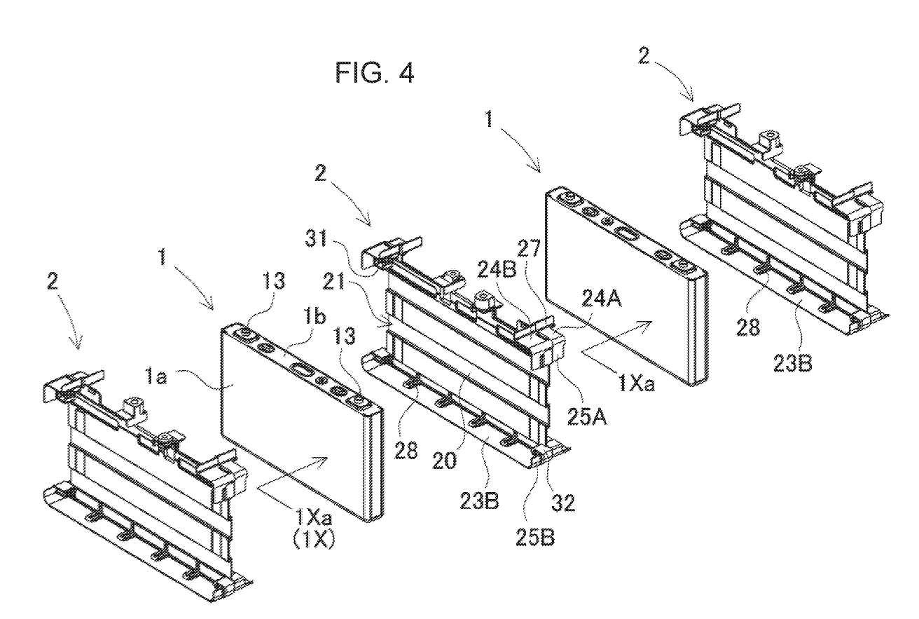

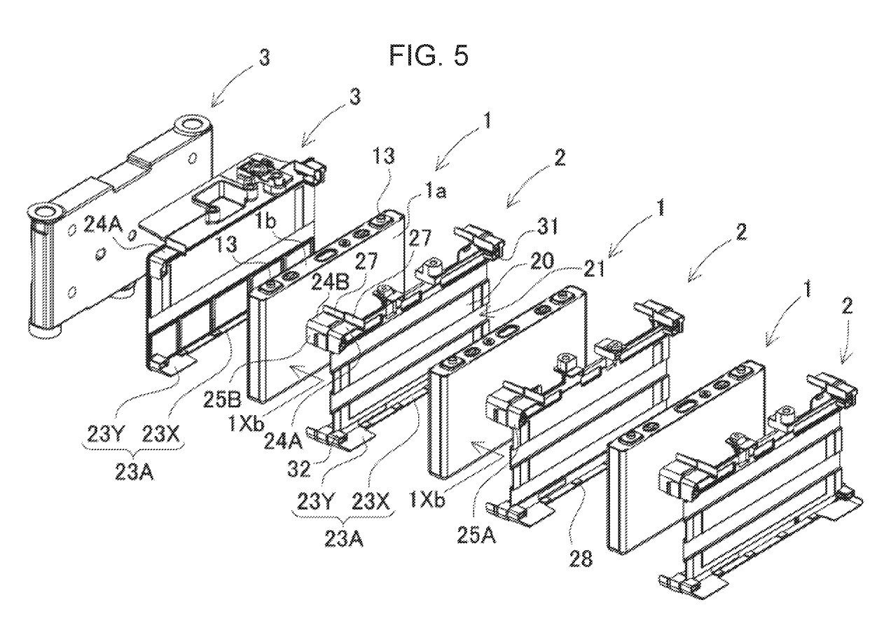

Battery cell 1 is a thin rectangular cell having a rectangular outer shape with a thickness thereof thinner than a width thereof. Furthermore, battery cell 1 is a lithium ion secondary battery. However, in the power supply device of the present invention, a battery cell is not limited to a lithium ion secondary battery, and any chargeable batteries, for example, nonaqueous electrolyte secondary battery cells other than a lithium ion secondary battery cell, a nickel hydride battery cell can be used. In battery cell 1, an electrode body including positive and negative electrode plates that are stacked on each other is housed in outer can la, filled with an electrolytic solution, and airtightly sealed. As shown in FIGS. 4 and 5, outer can 1a is molded in a bottom-closed rectangular tubular shape, and an upper side opening part is airtightly closed by sealing plate 1b made of a metal plate. Outer can 1a is made by subjecting a metal plate of aluminum and an aluminum alloy to deep drawing. Sealing plate 1b is made of a metal plate of aluminum and an aluminum alloy similar to outer can 1a. Sealing plate 1b is inserted into the opening part of outer can 1a, and a boundary between the outer periphery of sealing plate 1b and the inner periphery of outer can 1a is irradiated with a laser beam, so that sealing plate 1b is airtightly laser-welded and fixed to outer can 1a.

As shown in FIGS. 4 to 6, in battery cell 1, positive and negative electrode terminals 13 are fixed to protrude on both ends of sealing plate 1b. Positive and negative electrode terminals 13 are connected to incorporated positive and negative electrode plates (not shown), respectively. Electrode terminals 13 fixed on the upper surface of batter cell 1 are disposed such that positive and negative electrode terminals 13 are disposed right-left symmetrically. Thus, battery cells 1 are stacked with opposite in the right and left directions, so that positive and negative electrode terminals 13, which are adjacent in the vicinity, can be connected in series by bus bar 17 made of a metal plate. Power supply device in which battery cells 1 are connected in series can increase an output voltage and increase an output. However, in the power supply device, battery cells can be also connected in parallel and in series. Battery cells 1 as rectangular cells are stacked in a parallel orientation to each other with separator 2 sandwiched therebetween to form battery cell stack 9.

Note here that in the present application, the up-and-down directions of battery cell 1 are specified in the drawings. Furthermore, the side surface of battery cell 1 means a narrow-width surface disposed at both sides of battery cell stack 9 when a plurality of battery cells are stacked with principal surfaces 1X as wide surfaces face each other to form battery cell stack 9.

### (Separator 2)

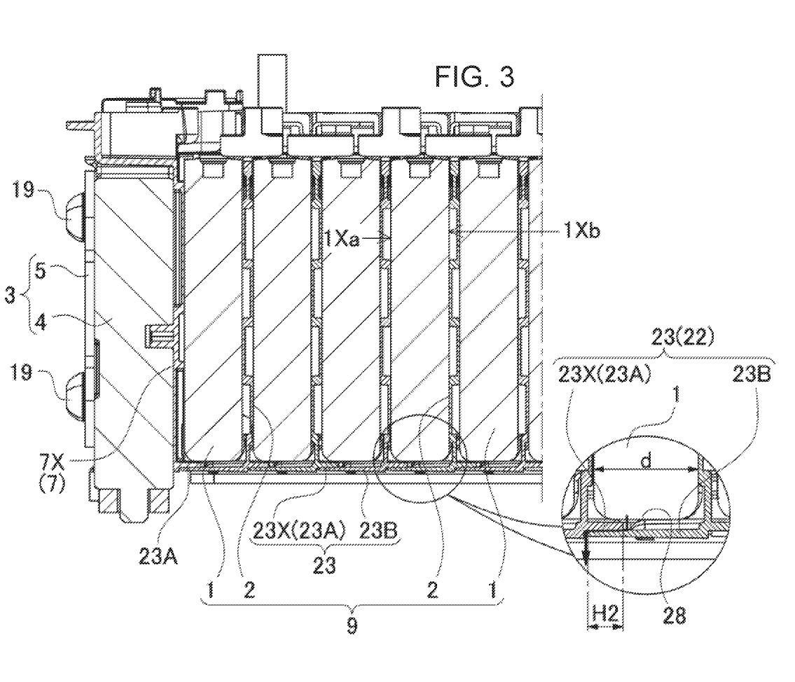

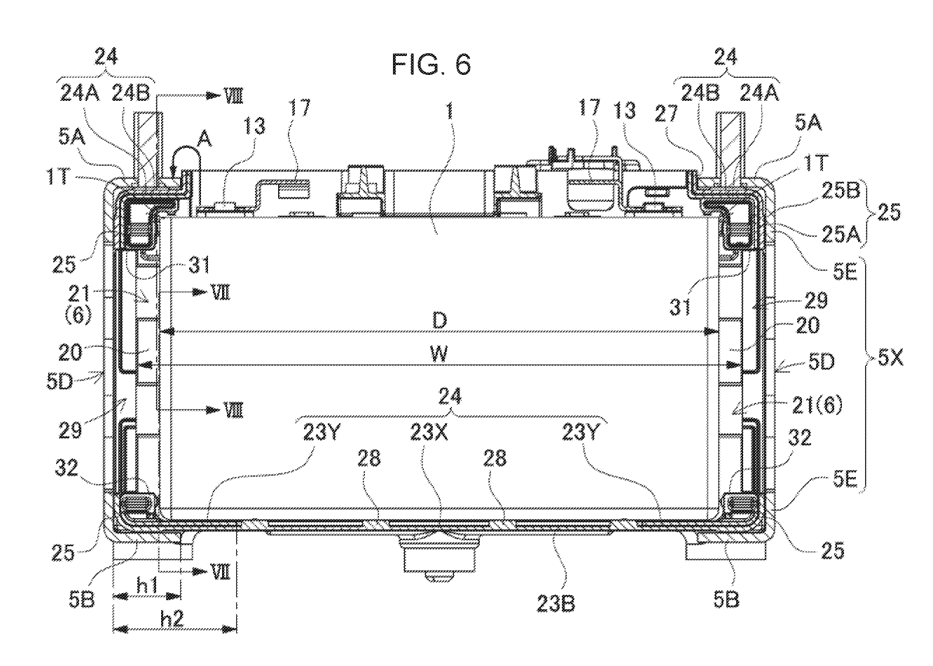

As shown in FIGS. 3 to 8, separator 2 is interposed between adjacent battery cells 1, and insulates adjacent battery cells 1 from each other with a predetermined interval maintained. Therefore, separator 2 is made of an insulating member to insulate outer cans 1a of adjacent battery cells 1 from each other. Such a separator 2 is made by molding an insulating material such as plastic. In order to supply surfaces of battery cells 1 with cooling air in a state in which separator 2 is interposed between battery cells 1, separator 2 has recesses and projections seen in a cross-sectional view so as to form air passage 6. Separator 2 shown in FIGS. 3 to 5, 7, and 8 is provided with air-flow groove 21 extending to the both side edges thereof on a surface facing battery cell 1. A gap made between air-flow groove 21 and principal surface 1X of battery cell 1 is defined as air passage 6. As shown in FIGS. 1 and 6, air passage 6 is provided in a horizontal direction and is opened to left and right side surfaces of battery cell stack 9.

Separator 2 of FIGS. 3 to 8 includes sandwiching plate portion 20 sandwiched between battery cells 1 adjacent to each other. To both surfaces of sandwiching plate portion 20, a plurality of lines of air-flow grooves 21 are alternately provided to form air passage 6. Air passages 6 formed on both surfaces of sandwiching plate portion 20 are in lines, and a plurality of lines is provided in parallel. This structure has a feature that air passages 6 formed on both sides of separator 2 can effectively cool the both sides of battery cells 1 at both sides. Note here that a separator can be also provided with an air-flow groove only on one side, and an air passage can be provided between the battery cell and the separator.

In sandwiching plate portion 20 shown in FIG. 6, a width (W) is larger than a width (D) of battery cell 1, and the both side parts are allowed to protrude outwardly from the side surfaces of battery cell 1. This structure enables a creepage distance between adjacent battery cells 1 to be secured. Adjacent battery cells 1 can be insulated from each other.

Furthermore, as shown in FIGS. 3 to 8, separator 2 is provided with outer peripheral cover portion 22, which protrudes in the stacked direction of battery cells, at the outer periphery of sandwiching plate portion 20. Outer peripheral cover portion 22 shown in the drawings includes bottom-surface cover portion 23 disposed at the lower end of separator 2 to cover the bottom surface of battery cell 1, upper-end cover portion 24 disposed at both sides of the upper end of separator 2 to cover the outside of the upper surface of battery cell 1, and side-surface cover portion 25 coupled to the side edges of bottom-surface cover portion 23 and upper-end cover portion 24 to cover the both sides of battery cell 1. As shown in FIGS. 4 and 5, bottom-surface cover portion 23, upper-end cover portion 24, and side-surface cover portion 25 are provided on both surfaces of separator 2 in such a manner that they protrude in a stacked direction of battery cells 1. As shown in FIGS. 3, and 6 to 8, outer peripheral cover portions 22 each including bottom-surface cover portion 23, upper-end cover portion 24, and side-surface cover portion 25 protruding on both surfaces of separator 2 are formed in such a manner that facing outer peripheral cover portions 22 are fitted to each other in a state in which separators 2 are stacked on battery cells 1.

Bottom-surface cover portion 23 is coupled to the lower end of sandwiching plate portion 20, and is provided in such a manner that it protrudes in the stacked direction of battery cells 1, that is, in the horizontal direction. Bottom-surface cover portion 23 covers the facing bottom surfaces of battery cell 1 in a state in which battery cells 1 and separators 2 are stacked. Separator 2 of FIGS. 3, 6 and 7 is unitarily formed with bottom-surface cover portion 23 protruding to the both surface sides from the lower end edge of sandwiching plate portion 20 since battery cells 1 are stacked on both surfaces of sandwiching plate portion 20. Bottom-surface cover portion 23 has a plate shape extending in the horizontal direction, and is provided over the entire lower end of sandwiching plate portion 20. Bottom-surface cover portion 23 shown in the drawings includes first bottom-surface cover portion 23A that protrudes to the first surface side of sandwiching plate portion 20 and second bottom-surface cover portion 23B that protrudes to the second surface side sandwiching plate portion 20. First bottom-surface cover portion 23A of separator 2 stacked on first principal surface 1Xa of battery cell 1 and second bottom-surface cover portion 23B of separator 2 stacked on second principal surface 1Xb of battery cell 1 are stacked on each other on bottom surfaces of battery cells 1 as shown in FIGS. 3, 6, and 7.

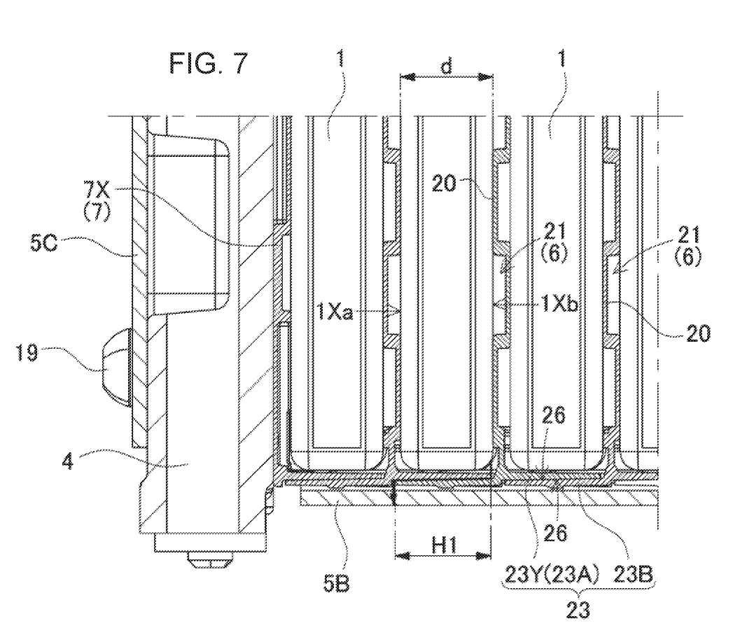

In bottom-surface cover portions 23 stacked on bottom surfaces of battery cells 1, a stacked width (H1) at the both ends in the width direction of battery cell 1 (see FIG. 7) is wider than a stacked width (H2) in the middle part (see FIG. 3). First bottom-surface cover portion 23A of separator 2 shown in FIG. 5 includes middle cover portion 23X for covering the middle part in the width direction of bottom surfaces of battery cells 1 and end cover portion 23Y for covering the both ends in the width direction of bottom surfaces of battery cells 1. A protruding amount of middle cover portion 23X is made smaller than that of end cover portion 23Y. The protruding amount of end cover portion 22Y is substantially equal to the thickness (d) of the battery cell as shown in FIG. 7. The protruding amount of middle cover portion 22X is about ⅓ of the thickness (d) of the battery cell as shown in FIG. 3.

As shown in FIG. 6, separator 2 having this structure is provided with end cover portion 23Y in a portion that is brought into contact with lower-end bending portion 5B of bind bar 5 mentioned below, thereby enabling a creepage distance in this portion to be increased. Thus, it is possible to effectively prevent short-circuit due to condensed water and the like. This is because in a site that is brought into contact with lower-end bending portion 5B of bind bar 5, lower-end bending portion 5B is provided directly below bottom-surface cover portion 23, and a distance to bind bar 5 becomes shorter, and the stacked width (H1) of bottom-surface cover portion 23 is increased to increase the creepage distance, thus enabling conduction due to condensed water and the like to be efficiently prevented. The stacked width (H1) at the both ends in bottom-surface cover portion 23 is made to be 10 mm or more, preferably 13 mm or more, thus making it possible to reliably prevent the short-circuit from this portion due to the condensed water.

Furthermore, in order to more reliably insulate the both ends of bottom-surface cover portion 23 from lower-end bending portion 5B of bind bar 5, separator 2 shown in FIG. 6 allows width (h1) of end cover portion 23Y of bottom-surface cover portion 23 facing lower-end bending portion 5B of bind bar 5 to be larger than covering width (h2) of lower-end bending portion 5B. Herein, when the width (h1) of end cover portion 23Y is made to be larger than the covering width (h2) of lower-end bending portion 5B by 5 mm or more, and preferably 10 mm or more, it is possible to reliably prevent short-circuit from this portion due to the condensed water.

On the contrary, since metal of bind bar 5 and the like is not disposed in the vicinity of the lower surface in the middle part of bottom surfaces of battery cells 1, even when a stacked width (H2) of bottom-surface cover portion 23 is small, a problem such as short-circuit does not occur. In separator 2, by reducing the stacked width (H2) in the middle part of bottom surfaces of battery cells 1, separator 2 is made to be compact in size, thus enabling molding or assembly to be simplified. When the stacked width (H2) of the middle part in bottom-surface cover portion 23 is 5 mm or more, and preferably 10 mm or more, it is possible to reliably prevent short-circuit from this portion due to the condensed water.

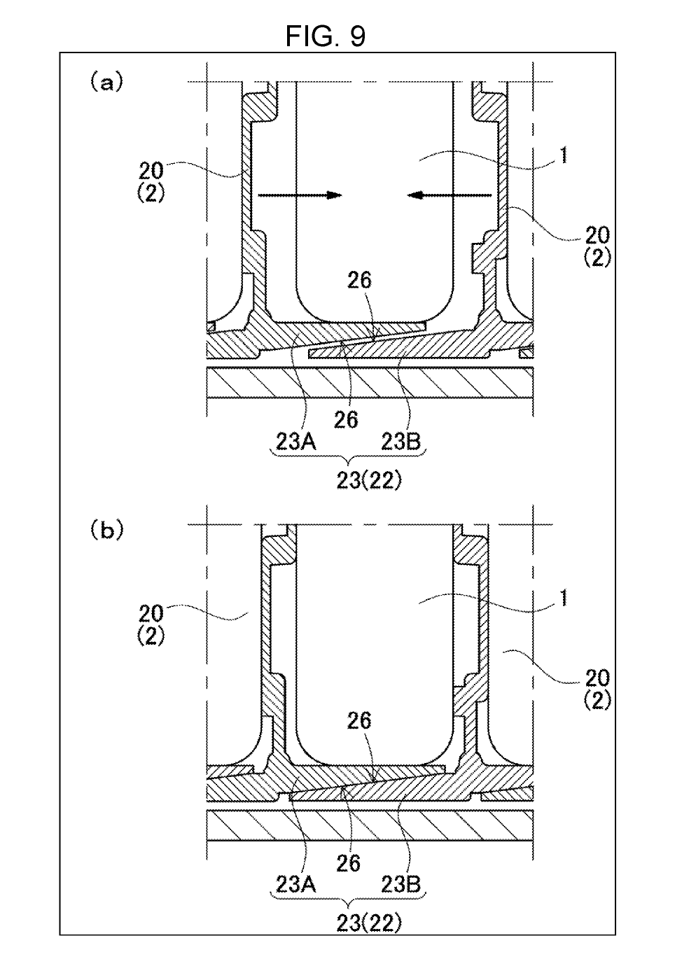

Furthermore, first bottom-surface cover portion 23A and second bottom-surface cover portion 23B are formed in such a manner they are gradually thinner from sandwiching plate portion 20 to the tip end, as shown in FIGS. 3 and 7, the facing surfaces that are stacked on each other are made to be tapered surfaces 26. As shown in FIG. 9, first bottom-surface cover portion 23A and second bottom-surface cover portion 23B are formed in tapered surfaces 26 in which the interval between the facing surfaces becomes narrower in a state in which they are made near to each other. In first bottom-surface cover portion 23A and second bottom-surface cover portion 23B of this structure, facing tapered surfaces 26 are closely attached to each other in a state in which battery cell stack 9 is fastened by fastening members 3, in other words, in a state in which separators 2 stacked on the both sides of battery cell 1 are pressed from the both sides so as to press principal surface 1X of battery cell 1 as shown in a schematic sectional view of FIG. 9. Thus, facing surfaces of first bottom-surface cover portion 23A and second bottom-surface cover portion 23B are closely attached to each other without a gap, so that it is possible to reliably prevent the conducting to the outside through condensed water or the like that passes through first bottom-surface cover portion 23A and second bottom-surface cover portion 23B. If there is a gap between the first bottom-surface cover portion and the second bottom-surface cover portion, water passes through the gap by capillary phenomenon to cause conduction to the outside. On the contrary, in the structure shown in the drawings, since first bottom-surface cover portion 23A and second bottom-surface cover portion 23B are closely attached to each other without a gap, thus making it possible to reliably prevent condensed water from passing therethrough. In particular, when the facing surfaces are tapered surfaces 26, first bottom-surface cover portion 23A and second bottom-surface cover portion 23B can be reliably coupled to each other in such a manner that they are closely attached to each other without a gap while clearance due to dimensional error etc., is absorbed. Note here that in the present application, facing outer peripheral cover portions (for example, first bottom-surface cover portion 23A and second bottom-surface cover portion 23B) are closely attached to each other without a gap means that they are made near to each other to such a degree that water does not pass through the gap. There may be a gap through which air passes.

Furthermore, bottom-surface cover portion 23 shown in FIGS. 3 to 7 includes a plurality of protrusions 28 so as to be brought into contact with a bottom surface of battery cell 1, for positioning. Bottom-surface cover portion 23 shown in the drawings is provided with a plurality of protrusions 28 extending in the stacked direction of battery cells 1, on the facing surface to bottom surface of the battery cell. Bottom-surface cover portion 23 shown in the drawings is provided with protrusions 28 in both facing positions of first bottom-surface cover portion 23A and second bottom-surface cover portion 23B. Separator 2 can be positioned such that the upper surface of protrusion 28 is brought into contact with the bottom surfaces of battery cells 1 in a state in which it is sandwiched from both sides of battery cell 1.

Upper-end cover portion 24 is disposed on upper surface side of upper-end corner part 1T that is a boundary portion between the upper surface and the side surface of battery cell 1, and is unitarily coupled to the upper-end corner portion of sandwiching plate portion 20 as a plate shape formed in parallel to the upper surface of battery cell 1. Upper-end cover portion 24 shown in FIGS. 4 to 6, and 8 includes first upper-end cover portion 24A protruding to the first surface side of sandwiching plate portion 20 and bottom-surface cover portion 23B protruding to the second surface side of sandwiching plate portion 20. First upper-end cover portion 24A and second upper-end cover portion 24B are stacked on each other at the upper surface side of battery cell 1.

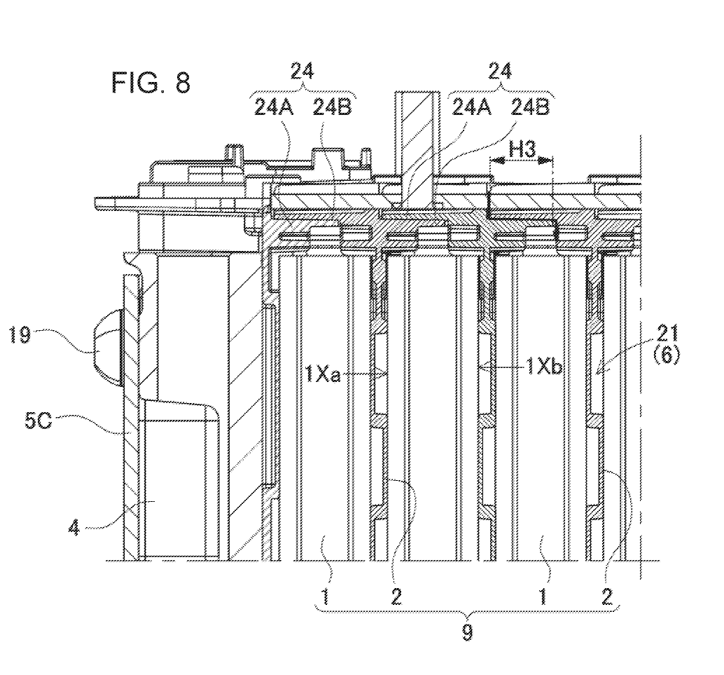

As shown in FIG. 8, in upper-end cover portions 24 stacked on each other at the upper surface side of battery cell 1, a stacked widths (H3) of first upper-end cover portion 24A and second upper-end cover portion 24B is made larger than ½ of the thickness (d) of the battery cell. In this structure, as shown in FIG. 6, upper-end bending portion 5A of the below-mentioned bind bar and the upper-end cover portion 24 that is brought into contact thereto are stacked on each other. This structure makes it possible to increase a creepage distance in this portion and to effectively prevent short-circuit due to condensed water and the like in this portion. When the width (H3) in which first upper-end cover portion 24A and second upper-end cover portion 24B are stacked on each other is 5 mm or more, and preferably 10 mm or more, it is possible to reliably prevent short-circuit from this portion due to condensed water and the like. Also facing surfaces of first upper-end cover portion 24A and second upper-end cover portion 24B shown in FIG. 8 are tapered surfaces, they can be closely attached to each other without a gap in a state in which they are pressed in a mutually approaching direction.

Furthermore, upper-end cover portion 24 shown in FIG. 6 is provided with standing portion 27 by raising a tip end portion at the electrode terminal 13 side of battery cell 1. In this way, a concept for providing standing portion 27 between the tip edge of bind bar 5 and the upper surface of the battery cell has a feature capable of increasing a creepage distance in this portion. This standing portion can be ideally insulating, when a protruding amount from the upper surface of upper-end bending portion 5A of bind bar 5 is set to, for example, 3 mm or more, and preferably 5 mm.

Furthermore, separator 2 shown in FIG. 6 is provided with positioning part 31 at the inner side of upper-end cover portion 24. Positioning part 31 makes it possible to dispose battery cell 1 in a predetermined position of separator 2. Positioning part 31 shown in the drawings has a pipe portion protruding in the stacked direction of the battery cells. A surface facing battery cell 1 is formed in a shape along a surface of upper-end corner part 1T of battery cell 1, in other words, a shape along the upper surface and the side surface of battery cell 1. The cylinder portion as positioning part 31 is provided at the inner side of first upper-end cover portion 24A and second upper-end cover portion 24B. In particular, the pipe portion as positioning part 31 uses a part of the upper surface also for first upper-end cover portion 24A.

Side-surface cover portion 25 is coupled to side edges of bottom-surface cover portion 23 and upper-end cover portion 24, and disposed to the outside of the side surface of battery cell 1 in the vertical orientation. Side-surface cover portion 25 is not provided continuously from the upper end to the lower end of separator 2. Side-surface cover portion 25 is provided in the upper part and the lower part. A middle part therebetween is provided with an opening part for forcedly blowing cooling air between separators 2 and battery cells 1. Side-surface cover portion 25 provided at the upper part of separator 2 is disposed in the vertical orientation downwardly with the upper end thereof connected to the side edge of upper-end cover portion 24. Side-surface cover portion 25 provided at the lower part of separator 2 is raised upwardly in the vertical orientation with the lower end thereof connected to the side edge of bottom-surface cover portion 23.

Side-surface cover portion 25 shown in FIGS. 4 to 6 includes first side-surface cover portion 25A protruding to the first surface side of sandwiching plate portion 20 and second side-surface cover portion 25B protruding to the second surface side of sandwiching plate portion 20. First side-surface cover portion 25A and second side-surface cover portion 25B are stacked on each other at the side surface side of battery cell 1. This side-surface cover portion 25 also has a stacked width in which first side-surface cover portion 25A and second side-surface cover portion 25B are stacked on each other can be 5 mm or more and preferably 10 mm or more.

Furthermore, separator 2 shown in FIG. 6 is provided with positioning parts 31 and 32 at the inner side of side-surface cover portion 25. Positioning parts 31 and 32 makes it possible to dispose battery cell 1 in a predetermined position of separator 2. Side-surface cover portion 25 provided to the upper part of separator 2 includes a pipe portion as positioning part 31 at the inner side of first side-surface cover portion 25A and second side-surface cover portion 25B. Furthermore, side-surface cover portion 25 provided to the lower part of separator 2 as positioning part 32 at the inner side of first side-surface cover portion 25A and second side-surface cover portion 25B. Positioning part 32 shown in the drawing is a pipe portion protruding in the stacked direction of the battery cells, and is formed in shape in which a surface facing battery cell 1 is along the side surface of battery cell 1.

The above-mentioned side-surface cover portion 25 covers the both side surfaces of battery cell 1, is disposed between side plate portion 5X of bind bar 5 disposed on the side surface of battery cell stack 9 and the side surface of battery cell 1, and functions as an insulating wall that insulates between these side surfaces. Separator 2 of FIG. 6 disposes side-surface cover portion 25 disposed in the upper and lower parts with a predetermined distance from the side surface of battery cell 1 via positioning parts 31 and 32 coupled to the upper and lower sides of the both side edges of sandwiching plate portion 20. Thus, spatial distance between side plate portion 5X of the bind bar disposed to the outer side of side-surface cover portion 25 and battery cell 1 is secured. The side-surface cover portion 25 is disposed in the position apart from the side surface of battery cell 1 by, preferably 8 mm or more, and further preferably 10 mm or more.

Furthermore, separator 2 shown in FIG. 6 is provided with cut regions 29 on both sides thereof such that both end opening parts of air passage 6 are positioned at the inner side from the side surface of battery cell stack 9. In separator 2 in the drawing, in the vicinity of the both side surfaces of battery cell stack 9, a side edge part of sandwiching plate portion 20 is allowed to protrude from the side surface of battery cell 1, and cut region 29 that is cut away as a recess is formed at the outer side of the both side edges of sandwiching plate portion 20. In this way, when cut region 29 formed by cutting away the outer side of sandwiching plate portion 20 is provided, an inlet side and an outlet side of air passage 6 are widened, thus suppressing generation of turbulent flow. Thus, pressure loss can be reduced. In particular, when cooling air supplied via the below-mentioned blower duct is guided into a thin slit, generation of loss is increased. Furthermore, generation of loss is also increased by bending a flowing direction of cooling air from the stacked direction of battery cells 1 are to a direction perpendicular to the stacked direction. Therefore, when cut region 29 is formed by cutting away separator 2 at the inlet side, space is secured at the inlet side of air passage 6, the cooling air is stored in this space once, and then guided into each air passage 6. Thus, cooling air can be guided smoothly with pressure loss reduced. Furthermore, similarly, when a large opening is provided at the outlet side, pressure loss can be reduced.

### (Battery Cell Stack)

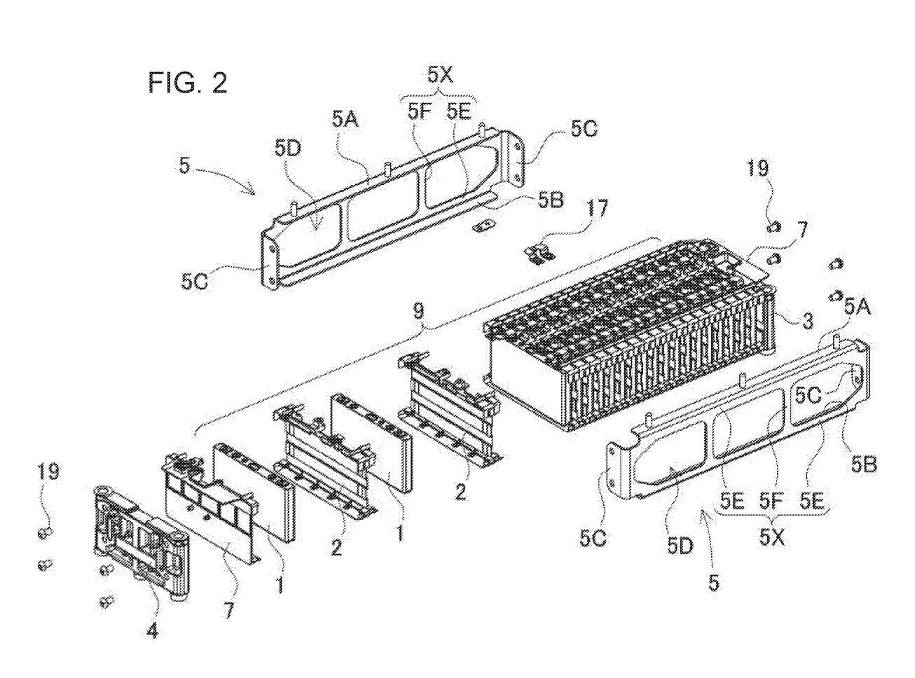

Battery cell stack 9 includes a plurality of battery cells 1 and separators 2 which are alternately stacked on each other, as shown in FIGS. 2 to 5. In battery cell stack 9, mutually adjacent battery cells 1 are stacked with insulating separators 2 interposed therebetween, thus insulating adjacent battery cells 1 from each other by separators 2. Separator 2 stacked between the mutually adjacent battery cells 1 is sandwiched between battery cells 1 provided at both sides, and separators 2 sandwich battery cell 1 stacked between the mutually adjacent separators 2 to maintain them in the predetermined positions. In other words, battery cell 1 is positioned from both sides by separators 2 stacked on both sides.

### (Fastening Member 3)

Battery cell stack 9 obtained by stacking a plurality of battery cells 1 and separators 2 is fastened by fastening members 3 in a stacked direction as shown in FIGS. 1 and 2. Fastening member 3 includes end plates 4 disposed at both end surfaces of battery cell stack 9, and bind bar 5 fixed to end plates 4 at the ends thereof and fixing stacked battery cells 1 with pressure applied. In battery cell stack 9, a pair of end plates 4 disposed at both end surfaces thereof are coupled by bind bar 5, and fixed in a state in which stacked battery cells 1 are pressurized in a direction orthogonal to principal surface 1X. However, fastening members are not necessarily limited to an end plate and a binding member. Any fastening members having a structure capable of fastening a battery cell stack in a stacked direction can be used.

### (End Plate 4)

End plate 4 is entirely made of metal. End plate 4 made of metal can achieve excellent strength and durability. End plate 4 shown in the drawings is entirely made of aluminum or an aluminum alloy. End plate 4 made of metal, as a die-cast, can be molded into a predetermined shape. In particular, a structure in which end plate 4 is made of an aluminum die-cast can achieve excellent workability and corrosion resistance while the entire weight is reduced. However, an end plate can be made of any metal other than aluminum or an aluminum alloy. In addition, examples of a manufacturing method include, other than die-cast molding, pressing, cutting, welding, bolt-fastening, and combination processing, and the like. The end plate made of metal is stacked on battery cell 1 via an end separator as an insulating material.

### (Bind Bar 5)

As shown in FIGS. 1 and 2, bind bars 5 couple end plates 4 on both ends of battery cell stack 9 and fix a plurality of battery cells 1 with pressure applied in a stacked direction. Bind bar 5 is made by subjecting a metal plate to press working. For bind bar 5, a metal plate such as an iron plate, preferably, a steel plate can be used. Bind bar 5 shown in the drawings includes side plate portion 5X disposed at the side surface of battery cell stack 9, and fixing portion 5C disposed at both ends of side plate portion 5X and outer end surface of end plate 4. Fixing portion 5C is fixed to the outer end surface of end plate 4 via set screw 19. Bind bar 5 shown in FIGS. 5 to 8 is fixed to end plate 4 via set screw 19, but it can be coupled to the end plate by bending the end portion of the bind bar inwardly, or by caulking the end portion to the end plate.

Furthermore, as shown in FIGS. 2 and 6, bind bar 5 includes upper-end bending portion 5A disposed at the side edge part of the upper surface side of battery cell stack 9, and lower-end bending portion 5B disposed at the side edge part of the lower surface side of battery cell stack 9. Battery cell stack 9 is disposed between upper-end bending portion 5A and lower-end bending portion 5B. Bind bar 5 shown in the drawings is provided with upper-end bending portion 5A by bending the upper edge of side plate portion 5X inwardly at a right angle, and is provided with lower-end bending portion 5B by bending the lower edge inwardly at a right angle. Furthermore, side plate portion 5X is provided with air-flow opening 5D inside excluding the outer peripheral edge portion so as to form a shape in which cooling air is allowed to flow through bind bar 5. Furthermore, with air-flow opening 5D, the weight of the entire bind bar 5 can be reduced. Side plate portion 5X of FIG. 2 couples rectangular peripheral edge plate portion 5E at the outer peripheral edge portion vertically using coupling bar 5F to reinforce peripheral edge plate portion 5E, and air-flow opening 5D is provided at the inner side of peripheral edge plate portion 5E.

As shown in FIG. 6, lower-end bending portion 5B of bind bar 5 is disposed to the lower surface of bottom-surface cover portion 23 of separator 2. In separator 2 shown in the drawing, end cover portions 23Y are provided to both ends of bottom-surface cover portion 23. Lower-end bending portion 5B is disposed to the lower surface of end cover portion 23. A structure in which lower-end bending portion 5B of bind bar 5 is disposed on the lower surface of bottom-surface cover portion 23, in particular, on the lower surface of end cover portion 23Y makes it possible to increase a creepage distance between battery cell 1 and bind bar 5 by end cover portion 23Y having a large stacked width (H1).

In the above-mentioned bind bar 5, in a state in which side plate portion 5X is disposed to the side surface of the battery cell stack, peripheral edge plate portion 5E is disposed to the outside of side-surface cover portion 25 of separator 2, upper-end bending portion 5A is disposed to the upper surface of upper-end cover portion 24 of separator 2, and lower-end bending portion 5B is disposed to the lower surface of bottom-surface cover portion 23 of separator 2. As mentioned above, bind bar 5 that is in contact with separator 2 via upper-end cover portion 24, bottom-surface cover portion 23, and side-surface cover portion 25, as outer peripheral cover portion 22 of the separator, can be insulated from battery cells reliably because a creepage distance is secured by outer peripheral cover portion 22 connected by a stacked structure.

### (End Separator 7)

Furthermore, in power supply device 100 shown in the drawings, end plates 4 are disposed to the outside of battery cells 1, which are disposed on both ends of battery cell stack 9, via end separators 7. In this structure, battery cells 1 having outer can 1a made of metal and end plates 4 made of metal can be stacked on each other while they are insulated from each other using insulating end separators 7. As shown in FIGS. 2 to 5, end separators 7 are disposed between battery cell stacks 9 and end plates 4, thus insulating end plates 4 made of metal from battery cells 1.

Furthermore, similar to the above-mentioned separator 2, end separator 7 is provided with outer peripheral cover portion 22 so as to be fitted into outer peripheral cover portion 22 of the facing separator 2. In other words, at one end of battery cell stack 9, as shown in FIGS. 5, 7, and 8, first bottom-surface cover portion 23A, first upper-end cover portion 24A and first side-surface cover portion 25A are provided to protrude on the surface at the battery cell 1 side of end separators 7 stacked to face first principal surface 1Xa of battery cell 1. End separator 7 shown in the drawings includes plate portion 7X between end plate 4 and battery cell 1. To plate portion 7X, first bottom-surface cover portion 23, first upper-end cover portion 24, and first side-surface cover portion 25 are unitarily molded. Furthermore, although not shown, at the other end of battery cell stack 9, second bottom-surface cover portion 23B, second upper-end cover portion 24B and second side-surface cover portion 25B are provided to protrude to battery cell 1 side surface of end separator 7 stacked to face second principal surface 1Xb of battery cell 1. End separator 7 is also provided with air-flow grooves extending to both side edges on facing surfaces of battery cell 1, and thus air passage 6 can be provided with respect to principal surface 1X of battery cell 1.

### (Bus Bar)

In the plurality of battery cells 1 constituting battery cell stack 9, positive and negative electrode terminals 13 are connected in series via bus bar 17. A power supply device including the plurality of battery cells 1 connected in series can increase an output voltage. However, the power supply device can also increase electric current capacity by connecting battery cells in parallel.

### (Blower Duct 41)

As shown in FIG. 1, power supply device 100 includes a pair of blower ducts 41 at both sides for forcedly blowing cooling air to air passage 6 provided between battery cell 1 and separator 2. Forced blower mechanism 42 is coupled to blower duct 41. Power supply device 100 forcedly blows cooling air from blower duct 41 to air passage 6 to cool battery cell 1. However, power supply device 100 can warm battery cell 1 by forcedly blowing warming air from blower duct 41 to air passage 6.

Blower duct 41 includes inlet duct 41A and exhaust duct 41B. Inlet duct 41A and exhaust duct 41B are provided opposite to each other. Cooling air is allowed to flow from inlet duct 41A to air passage 6, and from air passage 6 to exhaust duct 41B to cool battery cell 1. A plurality of air passages 6 is connected in parallel to inlet duct 41A and exhaust duct 41B. Therefore, the cooling air that is allowed to flow to inlet duct 41A is branched into a plurality of air passages 6 and allowed to flow from inlet duct 41A to exhaust duct 41B. Since power supply device 100 shown in FIG. 1 includes inlet duct 41A and exhaust duct 41B at both sides, air passage 6 is provided to extend in horizontally. The cooling air is allowed to flow into air passage 6 horizontally to cool battery cell 1. Note here that the shape of blower duct is not necessarily limited to the shape shown in FIG. 1 as an example. A blower duct can be provided along the direction in parallel with respect to air passage 6.

### (Forced Blower Mechanism 42)

Forced blower mechanism 42 includes a fan rotated by a motor, and this fan is connected to blower duct 41. In power supply device 100, for example, forced blower mechanism 42 is coupled to inlet duct 41A, and cooling air is forced to blow from forced blower mechanism 42 to inlet duct 41A. Power supply device 100 allows cooling air to flow from forced blower mechanism 42→inlet duct 41A→air passage 6→exhaust duct 41B so as to cool battery cell 1. However, a forced air blower can be coupled to an exhaust duct. This blower forces cooling air to absorb from the exhaust duct and to exhaust cooling air. Therefore, this power supply device forces cooling air to flow from the inlet duct→air passage→exhaust duct→forced air blower so as to cool battery cell.

The power supply device described above can be used for a vehicle-mounted battery system. Examples of a vehicle having a power supply device mounted include electric vehicles such as hybrid cars or plug-in hybrid cars driven by both an engine and a motor, or electric-motor driven automobiles such as electric automobiles only driven by a motor. The power supply device can be used for power supplies of these vehicles.

### (Power Supply Device for Hybrid Automobile)

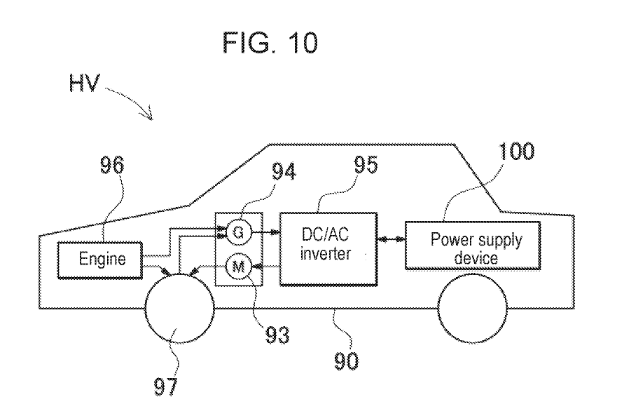

FIG. 10 shows an example in which a power supply device is mounted on a hybrid car driven by both an engine and a motor. A vehicle HV having a power supply device mounted thereon shown in the drawing includes engine 96 and drive motor 93 for driving the vehicle HV, power supply device 100 supplying electric power to motor 93, generator 94 charging a battery cell of power supply device 100, vehicle body 90 equipped with engine 96, motor 93, power supply device 100, and generator 94, wheel 97 for driving vehicle body 90 driven by engine 96 or motor 93. Power supply device 100 is connected to motor 93 and generator 94 via DC/AC inverter 95. The vehicle HV is driven by both motor 93 and engine 96 while the battery of power supply device 100 is charged and discharged. Motor 93 is driven in a region with low efficiency of the engine, for example, at the time of acceleration or driving at a low speed to drive the vehicle. Motor 93 is driven when electric power supplied from power supply device 100. Generator 94 is driven by engine 96 or regenerating braking at the time of braking the vehicle to charge the battery cell of power supply device 100.

### (Power Supply Device for Electric Automobile)

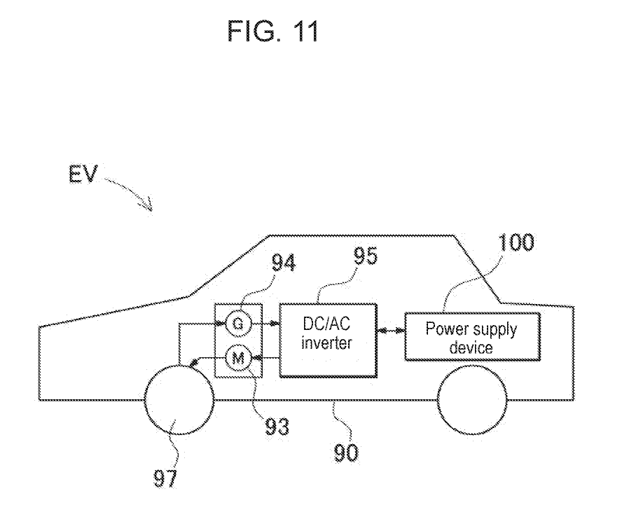

Furthermore, FIG. 11 shows an example in which a power supply device is mounted on an electric automobile only driven by a motor. A vehicle EV having a power supply device shown in the drawing mounted thereon includes drive motor 93 for driving the vehicle EV, power supply device 100 supplying electric power to motor 93, and generator 94 charging a battery of the power supply device 100, vehicle body 90 equipped with motor 93, power supply device 100, and generator 94, and wheel 97 for driving vehicle body 90 driven by motor 93. Power supply device 100 is coupled to motor 93 and generator 94 via DC/AC inverter 95. Motor 93 is driven by electric power supplied from power supply device 100. Generator 94 is driven by energy at the time of regenerating braking of the vehicle EV to charge the battery cell of power supply device 100.

In the above, the exemplary embodiments or examples according to the present invention are described with reference to the drawings. It should be appreciated, however, that the embodiments or examples described above are illustrations to embody technical ideas of the present invention, and the present invention is not specifically limited to description above. Furthermore, it should be appreciated that in the specification of the present application, the members shown in claims attached hereto are not specifically limited to members in the embodiments. Unless otherwise specified, any dimensions, materials, shapes and relative arrangements of the components described in the embodiments are given as an example and not as a limitation. Note here that the sizes and the positional relationships of the members in each of the drawings are occasionally shown larger exaggeratingly for ease of explanation. Members same as or similar to those of this invention are attached with the same designation and the same reference signs, and their description is appropriately omitted. In addition, a plurality of structural elements of the present invention may be configured as a single part that serves the purpose of a plurality of elements, on the other hand, a single structural element may be configured as a plurality of parts that serve the purpose of a single element.

### INDUSTRIAL APPLICABILITY

A power supply device according to the present invention can be suitably used as power supply devices of plug-in hybrid vehicles and hybrid electric vehicles that can switch between the EV drive mode and the HEV drive mode, electric vehicles, and the like.

### REFERENCE MARKS IN THE DRAWINGS

100 . . . power supply device
1 . . . battery cell

1X . . . principal surface

1Xa . . . first principal surface

1Xb . . . second principal surface

1T . . . upper-end corner part

1a . . . outer can

1b . . . sealing plate
2 . . . separator
3 . . . fastening member
4 . . . end plate
5 . . . bind bar

5X . . . side plate portion

5A . . . upper-end bending portion

5B . . . lower-end bending portion

5C . . . fixing portion

5D . . . air-flow opening

5E . . . peripheral edge plate portion

5F . . . coupling bar
6 . . . air passage
7 . . . end separator

7X . . . plate portion
9 . . . battery cell stack
13 . . . electrode terminal
17 . . . bus bar
19 . . . set screw
20 . . . sandwiching plate portion
21 . . . air-flow groove
22 . . . outer peripheral cover portion
23 . . . bottom-surface cover portion

23A . . . first bottom-surface cover portion

23B . . . second bottom-surface cover portion

23X . . . middle part cover portion

23Y . . . end cover portion
24 . . . upper-end cover portion

24A . . . first upper-end cover portion

24B . . . second upper-end cover portion
25 . . . side-surface cover portion

25A . . . first side-surface cover portion

25B . . . second side-surface cover portion
26 . . . tapered surface
27 . . . standing portion
28 . . . protrusion
29 . . . cut region
31 . . . positioning part
32 . . . positioning part
41 . . . blower duct

41A . . . inlet duct

41B . . . exhaust duct
42 . . . forced blower mechanism
90 . . . vehicle body
93 . . . motor
94 . . . generator
95 . . . DC/AC inverter
96 . . . engine
97 . . . wheel
HV . . . vehicle
EV . . . vehicle

1. A power supply device comprising:
a plurality of battery cells each having a thickness thinner than widths of principal surfaces, and having a rectangular outer shape;
separators each interposed between the battery cells and insulating mutually adjacent ones of the battery cells from each other, in a state that the plurality of battery cells are stacked with the principal surfaces facing each other; and
a fastening member for fastening a battery cell stack including the battery cells and the separators alternately stacked on each other,
wherein each of the separators includes
a sandwiching plate portion disposed between the facing principal surfaces of the mutually adjacent battery cells, and
a plate-like bottom-surface cover portion provided to both surfaces of the sandwiching plate portion, at a lower end of the sandwiching plate portion, and protruding in a stacked direction of the battery cells to cover bottom surfaces of the battery cells, and
the bottom-surface cover portions of the separators stacked on both surfaces of the battery cells are stacked on each other at the bottom surfaces of the battery cells.

2. The power supply device according to claim 1, wherein the bottom-surface cover portion includes a middle cover portion that covers a middle part in a width direction of the bottom surface of the battery cell; and end cover portions that cover both ends in the width direction of the bottom surface of the battery cell, and
a stacked width (H1) in one of the end cover portions is larger than a stacked width (H2) in the middle cover portion.

3. The power supply device according to claim 2, wherein
the fastening member includes a pair of end plates disposed to both end surfaces of the battery cell stack, and a bind bar having both ends of the bind bar connected to the pair of end plates;
the bind bar includes a side plate portion for covering at least a part of the side surface of the battery cell stack, and a lower-end bending portion extending from a lower end of the side plate portion, and covering a part of a bottom surface of the battery cell stack; and
the separators each include the end cover portion at a site facing the lower-end bending portion.

4. The power supply device according to claim 1, wherein the bottom-surface cover portion includes a first bottom-surface cover portion protruding to a first surface side of the sandwiching plate portion, and a second bottom-surface cover portion protruding to a second surface side of the sandwiching plate portion;
the first bottom-surface cover portion of one of the separators stacked on a first principal surface of the battery cell, and the second bottom-surface cover portion of another of the separators stacked on a second principal surface of the battery cell are stacked on each other at the bottom surface of the battery cells.

5. The power supply device according to claim 4, wherein the first bottom-surface cover portion and the second bottom-surface cover portion are formed to be gradually thinner from the sandwiching plate portion toward a tip end, and facing surfaces thereof that are stacked on each other are formed as a tapered surface, and
the facing surfaces of the first bottom-surface cover portion and the second bottom-surface cover portion are closely attached to each other in such a state that the battery cell stack is fastened by the fastening member.

6. The power supply device according to claim 1, wherein the separators each include an upper-end cover portion provided to both surface sides of the sandwiching plate portion, at an upper end of the sandwiching plate portion, and protruding in the stacked direction of the battery cells to cover an upper surface side of the battery cells, and
the upper-surface cover portions of the separators stacked on both surfaces of one of the battery cells are stacked on each other at the upper surface side of the battery cells.

7. The power supply device according to claim 6, wherein
the fastening member includes a pair of end plates disposed to both end surfaces of the battery cell stack, and a bind bar having both ends coupled to the pair of end plates,
the bind bar includes a side plate portion for covering at least a part of a side surface of the battery cell stack, and an upper-end bending portion that extends from an upper end of the side plate portion and covers a part of an upper surface of the battery cell stack; and
the separators each include the upper-end cover portion at a site facing the upper-end bending portion.

8. The power supply device according to claim 1, wherein in the separator, a width (W) of the sandwiching plate portion is larger than a width (D) of the battery cell.

9. The power supply device according to claim 1, wherein the separator has recesses and projections seen in a cross-sectional view of the sandwiching plate portion, for forming a plurality of lines of air passages between the sandwiching plate portion and the principal surfaces of the facing stacked battery cells.

10. A vehicle provided with a power supply device as defined in claim 1.
